(19) United States
(12) Patent Application Publication
(10) Pub. No.: US 2023/0031319 A1
(43) Pub. Date: Feb. 2, 2023

(54) WEARABLE DEVICE

(71) Applicant: GOERTEK INC., Weifang, Shandong (CN)

(72) Inventor: Xianjun Zhang, Weifang, Shandong (CN)

(21) Appl. No.: 17/788,665

(22) PCT Filed: Oct. 31, 2020
(86) PCT No.: PCT/CN2020/125628

§ 371 Date: Jun. 23, 2022

(30) Foreign Application Priority Data
Dec. 31, 2019 (CN) 201911411063.5

(51) Int. Cl. G04G 17/04; G04G 17/06; G04G 21/02

(52) U.S. Cl. CPC G04G 17/04; G04G 17/06; G04G 21/025

(57) ABSTRACT

A wearable device includes a device body and a strap body connected to the device body. The device body includes an upper housing and a lower housing fixedly connected. A circuit board is provided in an inner cavity formed by the upper housing and the lower housing. The upper housing includes an insulating portion and a meal portion fixedly connected to at least one end of the insulating portion. The metal portion is electrically connected to the circuit board and used as an upper electrode for monitoring biological information. The lower housing includes a lower body portion matching the insulating portion, and a lower connecting portion located on at least one end of the lower body portion. The upper electrode matches the lower connecting portion and is fixedly connected to the strap body.

The present application claims the benefit of priority to Chinese Patent Application No. 201911411063.5, titled “WEARABLE DEVICE”, filed with the China National Intellectual Property Administration on Dec. 31, 2019, which is incorporated herein by reference in its entirety.

### FIELD

The present application relates to the technical field of electronic devices, and in particular to a wearable device.

### BACKGROUND

Wearable devices such as wristbands and watches are widely used in people's lives. With the demands of users for diversified functions of the product, biological information monitoring functions such as heart rate detection and body fat detection are integrated in more and more wearable devices. Taking a watch as an example, for realizing general body fat detection, an upper electrode and a lower electrode are each individually arranged on a housing, where the upper electrode is assembled to a metal body by manners such as adhesive dispensing and the like, and the lower electrode is in contact with the user's wrist when the watch is worn by the user. When the user touches the upper electrode with a finger, a detection circuit is conducted, and the body fat detection can be performed.

However, the upper electrode is mounted on the metal body, since the upper electrode in a conventional design is a small piece, it is required to be assembled to the metal body by using materials such as an insulation strip and a screw. When the body fat is to be detected, only the upper electrode is required to be touched by the finger, and in a case that the metal body is touched, the body fat is detected inaccurately or is unable to be detected, which causes inconvenience of operation.

In summary, a problem to be addressed by those skilled in the art at present is to effectively solve the problem of inconvenient operation of wearable devices for monitoring biological information such as body fat.

### SUMMARY

In view of this, an object of the present application is to provide a wearable device with a structure that is designed to effectively solve the problem of inconvenient operation of the wearable device for monitoring biological information such as body fat.

In order to achieve the above object, the following technical solutions are provided according to the present application.

A wearable device includes a device body and a band body connected to the device body, where the device body includes an upper housing and a lower housing that are fixedly connected, a circuit board is provided in an inner cavity defined by the upper housing and the lower housing, the upper housing includes an insulation portion and a metal portion fixedly connected to at least one end of the insulation portion, two metal portions are electrically connected to the circuit board and serve as upper electrodes for monitoring biological information, the lower housing includes a lower body portion matching the insulation portion, and a lower connecting portion arranged at at least one end of the lower body portion, and the upper electrode and the lower connecting portion match each other, to be fixedly connected to the band body.

Preferably, in the wearable device, the lower housing is made of an insulation material, a lower electrode electrically connected to the circuit board is fixed at a lower surface of the lower housing, and the upper electrode and the lower electrode are conducted when both being in contact with user's skin, to monitor the biological information.

Preferably, in the wearable device, each of two ends of the insulation portion is provided with the upper electrode, respectively, one of the upper electrode and the lower connecting portion has spring bar holes arranged opposite to each other, and the one of the upper electrode and the lower connecting portion is connected to the band body via spring bars.

Preferably, in the wearable device, one of the upper electrode and the lower connecting portion is provided with a positioning groove, and the other is provided with a positioning protrusion inserted into the positioning groove for positioning.

Preferably, in the wearable device, the positioning protrusion is connected to a bottom of the positioning groove via a screw.

Preferably, in the wearable device, the bottom of the positioning groove is provided with a through hole having a size smaller than a size of a head of the screw, an end of the positioning protrusion has a screw post inserted into the through hole, the screw post is provided with a screw hole, and the screw is fixed in the screw hole with the head abutting outside the through hole.

Preferably, in the wearable device, the lower housing is a plastic housing.

Preferably, in the wearable device, a bottom surface of the lower housing has two electrode mounting grooves, and the lower electrode is fixedly mounted in each of the two electrode mounting grooves (36).

Preferably, in the wearable device, the upper electrode and the circuit board are electrically connected through an elastic sheet, and both ends of the elastic sheet each has a protrusion, and the protrusions are in contact with the upper electrode and the circuit board, respectively.

Preferably, in the wearable device, a pogo pin having one end welded to the circuit board is provided in the lower housing, and another end of the pogo pin is in contact with the lower electrode.

The wearable device according to the present application includes a device body and a band body connected to the device body. The device body includes an upper housing and a lower housing that are fixedly connected, a circuit board is provided in an inner cavity defined by the upper housing and the lower housing, the upper housing includes an insulation portion and a metal portion fixedly connected to at least one end of the insulation portion, the metal portion is electrically connected to the circuit board and serves as an upper electrode for monitoring biological information, the lower housing includes a lower body portion matching the insulation portion and a lower connecting portion arranged at at least one end of the lower body portion, and the upper electrode matches the lower connecting portion, to be fixedly connected to the band body.

In the wearable device according to the present application, the upper housing includes an insulation portion and a metal portion, and the metal portion directly serves as the upper electrode, such that when biological information is required to be monitored, a user may touch the upper electrode with a finger or the like, to monitor corresponding biological information. Since the upper electrode is a part of the conventional upper housing, the upper electrode and the metal housing can hardly been touched at the same time when the user intends to touch the upper electrode, which otherwise results in inaccurate detection or detection failing, thus the user's operation is greatly facilitated. In addition, the upper electrode and the lower connecting portion match each other, to be fixedly connected to the band body, that is, the upper electrode corresponds to the position where the band body is connected. Therefore, the upper electrode is less limited in space and has a relatively large size, which further facilitates the user's operation.

### BRIEF DESCRIPTION OF THE DRAWINGS

For more clearly illustrating embodiments of the present disclosure or the technical solutions in the conventional technology, drawings referred to for describing the embodiments or the conventional technology will be briefly described hereinafter. Apparently, drawings in the following description are only a part of drawings of the present application, and for the person skilled in the art, other drawings may be obtained based on the provided drawings without any creative efforts.

FIG. 1 is an exploded schematic view showing the structure of a device body of a wearable device according to a specific embodiment of the application;

FIG. 2 is a schematic view showing the structure of a cross section of the device body in FIG. 1;

FIG. 3 is an enlarged schematic view showing part of FIG. 2;

FIG. 4 is an enlarged schematic view showing part of a cross section taken at another position of the device body;

FIG. 5 is a partially enlarged schematic view showing a positioning protrusion and a positioning groove matching each other;

FIG. 6 is a schematic view showing the structure of a lower housing;

FIG. 7 is a partially enlarged schematic view showing part A in FIG. 6;

FIG. 8 is a partially enlarged schematic view showing part B in FIG. 6;

FIG. 9 is a bottom schematic view of a lower housing;

FIG. 10 is a schematic view showing the structure of an upper housing;

FIG. 11 is a schematic view showing the structure of an upper electrode; and

FIG. 12 is a schematic view showing the structure of the upper electrode from another perspective.

Reference numerals in the drawings:

| | | | |
|---|---|---|---|
| 1 | lens and screen module, | 2 | upper housing, |
| 21 | upper electrode, | 22 | insulation portion, |
| 23 | positioning protrusion, | 24 | screw post, |
| 25 | dispensing groove, | 26 | spring bar hole, |
| 3 | lower housing, | 31 | lower connecting portion, |
| 32 | lower body portion, | 33 | positioning groove, |
| 34 | through hole, | 35 | button hole, |
| 36 | electrode mounting groove, | 37 | groove, |
| 4 | elastic sheet, | 5 | battery bracket, |
| 6 | FPC double-sided tape for button, | 7 | button FPC module, |
| 8 | battery, | 9 | circuit board, |
| 10 | screw, | 11 | heart rate FPC, |
| 12 | lower electrode, | 13 | pogo pin 13. |

### DETAILED DESCRIPTION OF THE EMBODIMENTS

A wearable device is provided according to embodiments of the present application, to facilitate monitoring of biological information such as body fat and the like.

Technical solutions according to the embodiments of the present application will be described as follows in conjunction with the drawings in the embodiments of the present application. It is apparent that the described embodiments are only a part of the embodiments according to the present application, rather than all of the embodiments. Any other embodiments obtained by those skilled in the art based on the embodiments in the present application without any creative work fall in the protection scope of the present application.

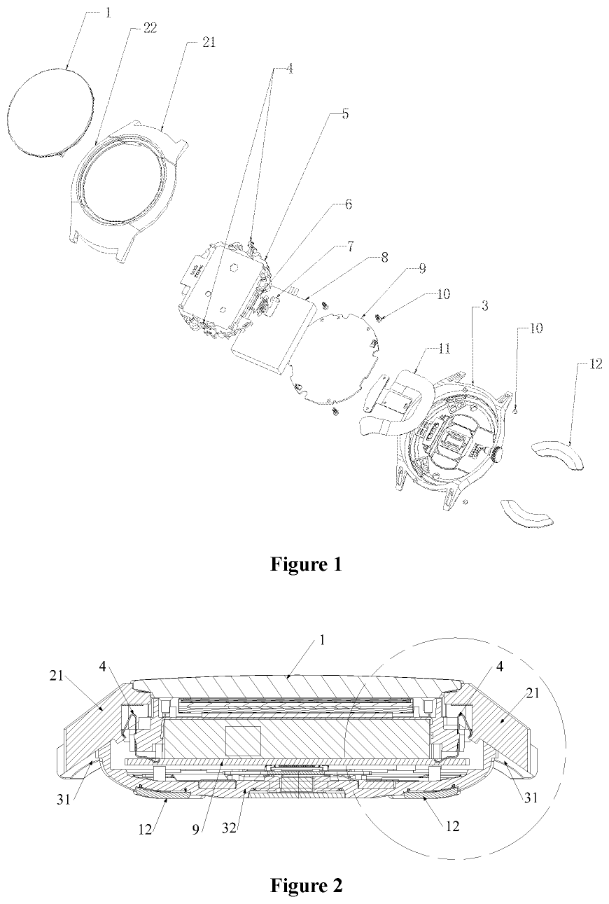

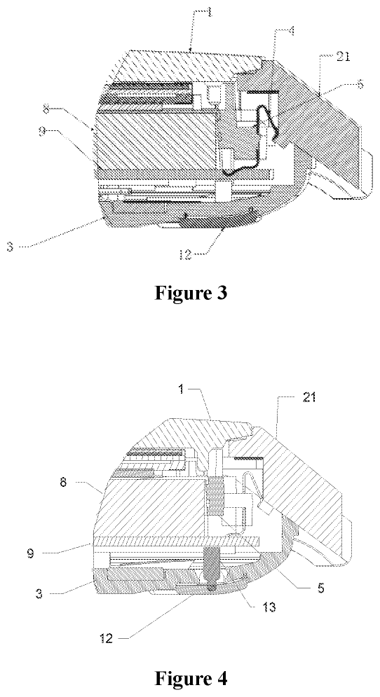

Reference is made to FIGS. 1 to 12. FIG. 1 is an exploded view showing the structure of a device body of a wearable device according to a specific embodiment of the present application, and FIGS. 2 to 12 are partially enlarged views showing different cross sections and components of FIG. 1.

In a specific embodiment, the wearable device according to the present application includes a device body and a band body connected to the device body.

The band body is used to allow the device body to be worn at a corresponding position of a user, for example, on the user's wrist as a watch or a wristband. The specific structure of the band body is based on the connection manner of the device body, which may refer to the conventional technology, and will not be repeated herein.

The device body includes an upper housing 2 and a lower housing 3 fixedly connected with each other. The lower housing 3 refers to a housing located at one end of the device body which is in contact with the user in a worn state, and the upper housing 2 is an opposite housing located at the other end. In a case that the wearable device has a lens and screen module 1, the lens and screen module 1 is fixed in the upper housing 2. Specifically, a lens mounting groove may be provided on the upper housing 2, and the lens and screen module 1 may be fixed in the lens mounting groove by adhesive dispensing or the like. The upper housing 2 and the lower housing 3 may be fixedly connected by screws or in a snap-fit manner, which is not specifically limited herein.

An inner cavity is formed between the upper housing 2 and the lower housing 3, and a circuit board 9 is provided in the inner cavity. The upper housing 2 includes an insulation portion 22 and metal portions fixedly connected to at least one end of the insulation portion 22, and each of the metal portions is connected to the circuit board 9 to serve as an upper electrode 21 for monitoring biological information. That is, the remaining portion of the upper housing 2 excluding the upper electrode 21 is made of insulation material. Specifically, opposite ends of the insulation portion 22 are each connected to the corresponding metal portion, that is, opposite ends of the housing each serves as the upper electrode 21, and a portion of the housing between the two upper electrodes 21 is the insulation portion 22, such that the two upper electrodes 21 are insulated from each other. In a case that the wearable device is a watch, the two metal portions may be provided in positions corresponding to 12 o'clock and 6 o'clock respectively. By using both ends as the upper electrode 21, an area that is usable is relatively large, so that the upper electrodes 21 have a larger contact area. In a case that the wearable device has a lens or a screen, most part of the lens or screen may be mounted in the insulation portion 22, and a small part of the lens or screen may be located in the metal portion, i.e., in the upper electrode 21. As shown in FIG. 10, a dispensing groove 25 may be specifically provided on the insulation portion 22, and the lens and screen module 1 is fixed at the dispensing groove by dispensing.

The lower housing 3 includes a lower body portion 32 that matches the insulation portion 22 and a lower connecting portion 31 located at at least one end of the lower body portion 32. The upper electrode 21 and the lower connecting portion 31 match each other, to be fixedly connected to the band body. Specifically, the lower connecting portion 31 may be made of an insulation material to isolate the upper electrode 21 from the skin such as the user's wrist. Specifically, the lower housing 3 is of an integral structure, and the lower connecting portion 31 is arranged in correspondence to the upper electrode 21. That is, in a case that each of the opposite ends of the insulation portion 22 is provided with the upper electrode 21, each of both ends of the lower body portion 32 is provided with the lower connecting portion 31. The upper electrode 21 and the lower connecting portion 31 match each other to be fixedly connected to the band body includes the case that the upper electrode 21 is fixedly connected to the band body, and the lower connecting portion 31 is fixed below the upper electrode 21, the case that the lower connecting portion 31 is fixedly connected to the band body, and the upper electrode 21 is fixed above the lower connecting portion 31, and the case that the upper electrode 21 is fixedly connected to the lower connecting portion 31, and the band body is fixed at the position where the upper electrode 21 and the lower connecting portion 31 are connected, that is, the band body is fixedly connected to both the upper electrode 21 and the lower connecting portion 31. In the case that each of the opposite ends of the insulation portion 22 is provided with the upper electrode 21, each upper electrode 21 at the both ends matches the corresponding lower connecting portion 31, to be fixedly connected to the both ends of the band body respectively. In a case that only one end of the insulation portion 22 is connected to the upper electrode 21, the other end of the band body may be connected to a position where the other end of the insulation portion 22 and the lower connecting portion 31 match each other.

The circuit connecting the upper electrode 21 and the circuit board 9 is conducted by touching the upper electrode 21 by the user, so as to monitor corresponding biological information. It should be noted that the biological information monitoring in this application may specifically be body fat monitoring, or may be monitoring such as electrocardiogram that may be performed through electrodes. For the convenience of illustration, the following are described by taking body fat monitoring as an example. Specifically, the circuit board 9 has a corresponding module, such as a bioimpedance detection module, which can obtain corresponding bioimpedance data when the circuit is conducted, so as to reflect the user's body fat monitoring result. The structure and detecting principle of the specific bioimpedance detection module may be referred to the conventional technology, which will not be repeated herein.

According to requirements, a lower electrode 12 matching the upper electrode 21 may be provided on a lower surface of the lower housing or a lower surface of the band body, and the upper electrode 21 and the lower electrode 12 are conducted when both are in contact with the user's skin, so as to monitor biological information. The number of the upper electrode 21 is generally one or two, which may be specifically provided as required. In a case that the number of the upper electrode 21 is two, the part of the upper housing 2 excluding the two upper electrodes 21 is made of insulation material. Since the upper electrode 21 directly serves as the upper housing 2, the upper electrode 21 may have a relatively large size, so as to further facilitate the user's operation. In addition, with the upper electrode 21 directly serving as the upper housing 2, it is not required to provide additional insulation material between the upper housing 2 and the upper electrode 21, which simplifies the structure, makes the structure simple to be machined and can be formed by CNC precision machining.

It should be noted that, in this application, the arrangement manner of the upper electrode 21 is mainly improved, and principles of conventional biological monitoring such as body fat monitoring in the conventional technology are still utilized. Therefore, the number of the upper electrode 21 and the lower electrode 12 may be set according to the number of electrodes required for conventional biological monitoring in the conventional technology, which is not limited herein.

In the wearable device according to the present application, at least part of the upper housing 2 is made of metal and serves as the upper electrode 21, that is, the upper electrode 21 is part of the conventional upper housing 2, and matches the lower electrode 12 located at the lower housing 3. In addition, since the lower housing 3 is made of insulation material, the upper electrode 21 and the lower electrode 12 are not conducted with each other. When the wearable device is worn by the user, the lower electrode 12 located at the lower housing 3 is in contact with the user. When biological information is required to be monitored, the user may contact the upper electrode 21 with a finger or the like, so that the upper electrode 21 and the lower electrode 12 are conducted to form a circuit, and thus corresponding biological information can be monitored. Since the upper electrode 21 directly serves as at least part of the upper housing 2, the upper electrode 21 and the metal housing can hardly be touched at the same time when the user intends to touch the upper electrode, which otherwise results in inaccurate detection or detection failing, thus the user's operation is greatly facilitated.

Specifically, the lower housing 3 is made of insulation material, thus the upper electrode 21 is isolated from the user's skin by the lower housing. When biological information monitoring is required, the user can touch the upper electrode 21 with a finger or the like, to conduct the circuit. Further, the lower electrode 12, which is electrically connected to the circuit board 9, is fixed on the lower surface of the lower housing 3, and the upper electrode 21 and the lower electrode 12 are conducted when both are in contact with the user's skin, so that the biological information can be monitored. Since the lower electrode 12 is fixed to the lower housing 3, the lower electrode 12 is naturally in contact with the user's skin when the wearable device is worn by the user. The upper electrode 21, serving as part of the upper housing 2, is not conducted with the lower electrode 12 and is not in contact with the skin of the user's wrist due to the existence of the lower housing 3. Both the upper electrode 21 and the lower electrode 12 are electrically connected to the circuit board 9, hence, when the user's finger or the like touches the upper electrode 21, the human body, as a conductor, makes the upper electrode 21 and the lower electrode 12 be conducted to form the circuit. Generally, two lower electrodes 12 may be provided. For example, the two lower electrodes 12 are fixed at intervals on the lower surface of the lower housing 3. Since the lower housing 3 is made of insulation material, it the two lower electrodes 12 are insulated from each other. For body fat monitoring, one or two upper electrodes 21 may be provided, to cooperate with the two lower electrodes 12 for detection. The specific principles of detection by cooperation between the electrodes may refer to the conventional technology, which will not be repeated herein.

Further, the upper electrode 21 has spring bar holes 26 disposed opposite to each other and is fixedly connected to the band body via spring bars, that is, the upper housing 2 is fixedly connected to the band body through the upper electrode 21. Since the upper electrode 21 is a metal portion, the band body can be reliably fixed by cooperation between the upper electrode 21 and the spring bars. The lower connecting portion 31 may also be provided with spring bar holes 26 according to requirements, and may be fixedly connected to the band body via spring bars. The band body and the device body are connected by the spring bars, which simplifies the structure and the occupied space is small. Of course, the band body and the device body are not limited to being connected via the spring bars, they may also be fixedly connected by other means such as buckles.

The upper housing 2 and the lower housing 3 adopt the above structure, that is, surfaces respectively extend from positions where the band body is connected at the both ends of the housing to the middle and are joined, to serve as a parting surface, to divide the housing of the device body as a whole into the upper housing 2 and lower housing 3. In other words, the housing as a whole is divided into the upper housing 2 and the lower housing 3 by an intermediate part in an up-down direction. Of course, the intermediate part herein refers to the part between the upper surface and the lower surface of the housing, which is not limited to the centerline. The upper housing 2 may further include the upper electrode 21 and the insulation portion 22 connected to the upper electrode 21. With the above parting manner of the upper housing 2 and the lower housing 3, when the wearable device is worn by the user, the upper housing 2 can be isolated from the user's skin by the lower housing 3.

Specifically, the upper electrode 21 and the lower connecting portion 31 are fixedly connected to fix the upper housing 2 and the lower housing 3. The upper housing 2 and the lower housing 3 are fixedly connected, and specifically may be realized by fixed connection between the upper electrode 21 and the lower connecting portion 31. For example, the upper electrode 21 and the lower connecting portion 31 are connected by a screw 10, and the upper housing 2 and the lower housing 3 are integrally fastened. This arrangement avoids occupation of the inner space of the insulation portion 22 and the lower body portion 32 by the fixed connection structure, thereby reserving a larger space for arrangement of the components.

In order to achieve precise positioning of the upper housing 2 and the lower housing 3, one of the metal portion and the lower connecting portion 31 is provided with a positioning groove 33, and the other is provided with a positioning protrusion 23 which is inserted into the positioning groove 33for positioning. When being assembled, the positioning protrusion 23 is inserted into the positioning groove 33, to facilitate the subsequent fixed connection of the upper housing 2 and the lower housing 3 through the precise positioning of the upper housing 2 and the lower housing 3. In addition, the precise matching of the upper housing 2 and the lower housing 3 ensures the good appearance of the device body. Specifically, the positioning protrusion 23 may be provided at the upper electrode 21, and the positioning groove 33 may be provided at the lower connecting portion 31. Of course, the positions of the positioning protrusion 23 and the positioning groove 33 may also be exchanged as required. It should be noted that since the positioning protrusion 23 and the positioning groove 33 match each other for positioning, the shapes of the two should be accordingly set. For example, when the positioning groove 33 is a rectangular groove, the positioning protrusion 23 should be a rectangular protrusion having a size corresponding to the rectangular groove, so that effective positioning can be achieved from all directions. In addition, the positioning groove 33 and the positioning protrusion 23 are arranged on the upper electrode 21 and the lower connecting portion 31 respectively and do not occupy space of the inner cavity. In order to have a better positioning effect, the upper electrode 21 located at each of both ends of the insulation portion 22 and the lower connecting portion 31 located at each of both ends of the lower body portion 32 are provided with the positioning groove 33 and the positioning protrusion 23 match each other, to realize precisely positioning at both ends of the upper housing 2 and the lower housing 3, which results in higher positioning precision. Of course, the positioning groove 33 and the positioning protrusion 23 may be only provided on the upper electrode 21 and the lower connecting portion 31 at one side as required.

Further, the positioning protrusion 23 is connected to a bottom of the positioning groove 33 through a screw 10. During assembly, after being inserted into the positioning groove 33, the positioning protrusion 23 is locked in the positioning groove 33 by the screw 10, thus the upper housing 2 and the lower housing 3 are fixed. With this arrangement, the assembly operation is convenient, the structure is simple, and the connection is reliable. Preferably, the positioning protrusion 23 is arranged on a lower end surface, facing the lower connecting portion 31, of the upper electrode 21, and the positioning groove 33 is provided on an upper end surface, facing the upper electrode 21, of the lower connecting portion 31, and the bottom of the positioning groove 33 is located on the bottom of the lower connecting portion 31. Therefore, after the screw 10 is connected to the bottom of the positioning groove 33 and the positioning protrusion 23, a head of the screw 10 is located at the bottom of the lower connecting portion 31, which will not affect the appearance of the upper housing 2, and the screw 10 is not prone to be loosened by external force when the wearable device is worn by the user.

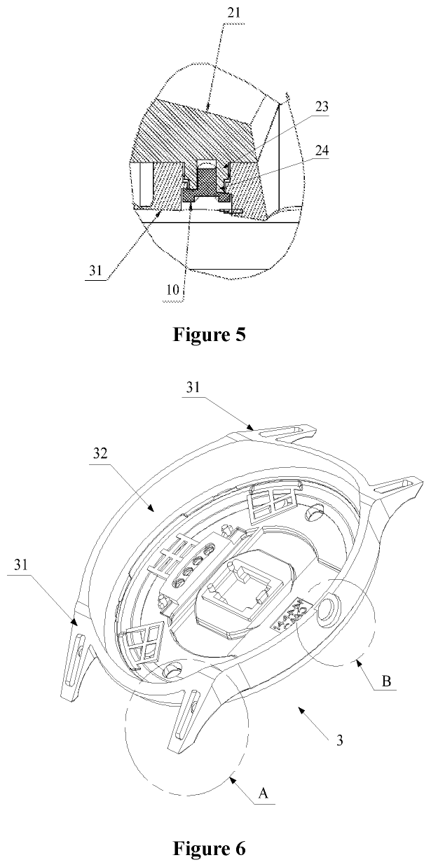

Further, the bottom of the positioning groove 33 is provided with a through hole 34 having a size smaller than a size of the head of the screw 10, and an end of the positioning protrusion 23 has a screw post 24 which is inserted into the through hole 34, and the screw post is provided with a hole for the screw 10, and the screw 10 is fixed in the hole for the screw 10 with the head abutting outside the through hole 34. As shown in FIGS. 5, 7 and 12, the bottom of the positioning groove 33 is provided with a through hole 34, and the screw post 24 at the end of the positioning protrusion 23 is inserted into the through hole 34. The shape and size of the screw post 24 are corresponding to that of the through hole 34. For example, in a case that the screw post 24 is of a shape of a cylinder, correspondingly, the through hole 34 is a round hole with the corresponding size, and thus the through hole 34 and the screw post 24 also play a role of precise positioning, which makes the positioning of the upper housing 2 and the lower housing 3 be more precise in combination of the positioning of positioning groove 33 and the positioning protrusion 23. The end surface of the screw post 24 is provided with the hole for the screw 10, and the screw 10 is tightly screwed into the hole; since the size of the head of the screw 10 is larger than the size of the through hole 34, the head of the screw 10 is blocked by the wall surface around the through hole 34, thus, the upper electrode 21 and the lower connecting portion 31 are fixedly connected. Preferably, a groove 37 is formed on an end face of the bottom of the positioning groove 33 away from the positioning groove 33, that is, one end of the through hole 34 is connected to the positioning groove 33, the other end is connected to the groove 37, and the head of the screw 10 is located in the groove 37, which prevent the head of the screw 10 from being exposed to the outside, so that the overall structure of the upper housing 2 and the lower housing 3 is more neat, in addition, the screw 10 may be prevented from being loosened by accidental force, so that the connection between the upper housing 2 and the lower housing 3 is more reliable.

Specifically, the case that the positioning protrusion 23 being arranged on the lower end surface, facing the lower connecting portion 31, of the upper electrode 21 and the positioning groove 33 being provided on the upper end surface, facing the upper electrode 21, of the lower connecting portion 31 is taken as an example, the groove 37 is provided on the lower end surface of the lower connecting portion 31, and the through hole 34a is provided in a wall surface between the groove 37 and the positioning groove 33, to make the groove 37 and the positioning groove 33 be in communication with each other, and the size of the through hole 34 is smaller than the size of the head of the screw 10. Thus, the screw post 24 is inserted into the through hole 34, the screw 10 is fixed into the hole for the screw 10 on the screw post 24, and the head of the screw 10 abuts outside the through hole 34, that is, abuts on the wall surface between the groove 37 and the positioning groove 33, thereby the upper housing 2 and the lower housing 3 are locked. Of course, since the screw 10 is used to lock the upper housing 2 and the lower housing 3, a stepped surface formed between the positioning groove 33 and the through hole 34 and a stepped surface formed between the positioning protrusion 23 and the screw post 24 should be prevented from interfering with the seamless connection between the upper housing 2 and the lower housing 3. A total length of the screw post 24 and the positioning protrusion 23 should not be greater than a total depth of the positioning groove 33 and the through hole 34, to avoid interference with the seamless connection of the upper housing 2 and the lower housing 3.

In one embodiment, a waterproof double-sided tape is provided between the positioning groove 33 and the positioning protrusion 23. That is, the waterproof double-sided tape may be provided at the same time that the positioning groove 33 and the positioning protrusion 23 are connected by the screw 10, so that high-level waterproofing, such as meeting the requirements of 5ATM waterproofing, may be achieved by providing the waterproof double-sided tape, that is, by bonding through the waterproof adhesive layer.

In the above embodiments, the lower housing 3 is a plastic housing. Plastic has a good performance of insulation, which can reliably ensure the requirements of antenna clearance. In addition, plastic is easily colored to meet the diverse color requirements of the housing of the wearable device. Moreover, the plastic material has a relatively good sense of touch, and the user has a better experience when the wearable device is worn. Of course, other conventional insulation materials may also be used for the lower housing 3 as required.

Specifically, the bottom surface of the lower housing 3 has two electrode mounting grooves 36, and the lower electrode 12 is fixedly mounted in each of the two electrode mounting grooves 36. That is, there are two lower electrodes 12. Specifically, the lower electrode 12 may be crescent-shaped, and the corresponding electrode mounting groove 36 is crescent-shaped. The lower electrode 12 may be fixed to the lower housing 3 by adhesive dispensing. As shown in FIG. 9, the two lower electrodes 12 are located at opposite ends of the lower housing 3. In a case that the wearable device is a watch, the two lower electrodes 12 may correspond to the positions of 12 o′clock and 6 o′clock respectively.

In the above embodiments, the upper electrode 21 and the circuit board 9 are electrically connected through an elastic sheet 4, and both ends of the elastic sheet 4 each has a protrusion, and the protrusions are in contact with the upper electrode 21 and the circuit board 9, respectively. The elastic sheet 4 is a sheet-like structure which occupies a small space, and the arrangement can be correspondingly adjusted according to the inner space between the upper housing 2 and the lower housing 3, to further reduce the space occupation on the premise that the effective electrical connection between the upper electrode 21 and the circuit board 9 is ensured. Each of both ends of the elastic sheet 4 has the protrusion. Specifically, the protrusion may be formed by stamping. The protrusion at one end is in contact with the upper electrode 21, specifically the side wall of the upper electrode 21, and the protrusion at the other end is in contact with the circuit board 9, which achieves effective connection between the upper electrode 21 and the circuit board 9. In a case that two upper electrodes 21 are provided, the elastic sheets 4 are arranged in a one-to-one correspondence with the upper electrodes 21, so as to be electrically connected to the circuit board 9 respectively. Specifically, the upper electrode 21 may be provided with a clamping position configured to abut against the end of the elastic sheet 4, so as to ensure reliable contact with the elastic sheet 4. According to requirements, the connection between the upper electrode 21 and the circuit board 9 is not limited to the connection by the elastic sheet 4, and other conventional electrical connection manner in the conventional technology may also be employed.

In the above embodiments, the lower electrode 12 is connected to the circuit board 9 through a pogo pin 13 (pogopin). That is, the pogo pin 13 having one end welded to the circuit board 9 is provided in the lower housing 3, and the other end of the pogo pin 13 is in contact with the lower electrode 12. Specifically, a piece attached to a top end of the pogo pin 13 is welded to the bottom surface of the circuit board 9, and a bottom end of the pogo pin 13 is in contact with the lower electrode 12. Specifically, in a case that a battery bracket 5 is provided, after the assembly of the battery bracket 5 is fixed to the lower housing 3, a pinhead of the pogo pin 13 is in contact with the lower electrode 12 to realize conduction.

During assembly, the lower electrode 12 may be specifically fixed to the lower housing 3, for example, being fixed to the lower housing 3 by adhesive dispensing. In a case that the wearable device is further used to detect the heart rate by photoplethysmography, the corresponding heart rate FPC 11 may be assembled in the lower housing 3, and specifically may be fixed in the lower housing 3 by heat fusion. The wearable electronic device generally has a battery 8, and the battery bracket 5 is provided to facilitate fixing the battery 8. Specifically, the circuit board 9 may be fixed on the battery bracket 5, for example, locked on the battery bracket 5 via the screw 10. The elastic sheet 4 is assembled to the battery bracket 5, and then the battery bracket 5 is fixed in the lower housing 3, for example, fixed in the lower housing 3 via the screw 10. The upper housing 2 and the lower housing 3 may be fixed by adhesive dispensing. In a case that the upper housing 2 includes the insulation portion 22 and the metal portion serving as the upper electrode 21, the upper electrode 21 and the insulation portion 22 are fixed on the lower housing 3 by adhesive dispensing. The lens and screen module 1 may be assembled at last.

A wearable device such as a watch generally has a button, a button hole 35 is provided on the lower housing 3, and the button is connected in the button hole 35 in a sealed manner. That is, the button is mounted in the lower housing 3 in a sealed manner. According to requirements, the button hole 35 may also be arranged in a manner that part of the button hole being provided in the upper housing 2 and the other part being provided in the lower housing 3, which may be set according to requirements of space. A button FPC module 7 is arranged in the lower housing 3 for matching the button, the specific structure and operating principles thereof may be referred to the conventional technology. In order to ensure the sealing performance, FPC double-sided adhesive tape 6 for the button may be provided. Specifically, the button hole 35 may be set at a position corresponding to three o'clock.

Specifically, the button includes a head portion and a rod portion, a tube is fixedly sleeved on the rod portion, the tube is in an interference fit with the button hole 35, and the head portion is located outside the button hole 35. The rod portion of the button is fixed with the tube, the tube is fixed with the button hole 35 by interference fit, and the function of sealing can be realized by the interference fit at the same time, so that the button is mounted on the lower housing 3 and the upper housing 2 in a sealed manner.

The above embodiments in this specification are described in a progressive manner. Each of the embodiments is mainly focused on describing its differences from other embodiments, and reference may be made among these embodiments with respect to the same or similar parts.

Based on the above description of the disclosed embodiments, those skilled in the art can implement or carry out the present application. Various modifications to these embodiments will be readily apparent to those skilled in the art, and the generic principles defined in the present application may be implemented in other embodiments without departing from the spirit or scope of the present application. Therefore, the present application shall not be limited to the embodiments described herein but have the widest scope that complies with the principle and novelty disclosed in this specification.

1. A wearable device, comprising:
a device body; and
a band body connected to the device body, wherein
the device body comprises an upper housing and a lower housing that are fixedly connected, a circuit board is provided in an inner cavity defined by the upper housing and the lower housing;
the upper housing comprises an insulation portion and a metal portion fixedly connected to at least one end of the insulation portion, the metal portion is electrically connected to the circuit board and serves as an upper electrode configured for monitoring biological information; and
the lower housing comprises a lower body portion matching the insulation portion, and a lower connecting portion arranged at at least one end of the lower body portion, and the upper electrode and the lower connecting portion match each other, to be fixedly connected to the band body.

2. The wearable device according to claim 1, wherein the lower housing is made of an insulation material, a lower electrode electrically connected to the circuit board is fixed at a lower surface of the lower housing, and the upper electrode and the lower electrode are conducted when both being in contact with user's skin, to monitor the biological information.

3. The wearable device according to claim 2, wherein a pogo pin having one end welded to the circuit board is provided in the lower housing, and another end of the pogo pin is in contact with the lower electrode.

4. The wearable device according to claim 1, wherein each of two ends of the insulation portion is provided with the upper electrode, one of the upper electrode and the lower connecting portion has spring bar holes arranged opposite to each other, and the one of the upper electrode and the lower connecting portion is connected to the band body via spring bars.

5. The wearable device according to claim 1, wherein one of the upper electrode and the lower connecting portion is provided with a positioning groove, and the other is provided with a positioning protrusion inserted into the positioning groove for positioning.

6. The wearable device according to claim 5, wherein the positioning protrusion is connected to a bottom of the positioning groove via a screw.

7. The wearable device according to claim 6, wherein the bottom of the positioning groove is provided with a through hole having a size smaller than a size of a head of the screw, an end of the positioning protrusion has a screw post inserted into the through hole, the screw post is provided with a screw hole, and the screw is fixed in the screw hole with the head abutting outside the through hole.

8. The wearable device according to claim 1, wherein the lower housing is a plastic housing.

9. The wearable device according to claim 8, wherein a bottom surface of the lower housing has two electrode mounting grooves, and the lower electrode is fixedly mounted in each of the two electrode mounting grooves.

10. The wearable device according to claim 1, wherein the upper electrode and the circuit board are electrically connected through an elastic sheet, and both ends of the elastic sheet each has a protrusion, and the protrusions are in contact with the upper electrode and the circuit board, respectively.

11. The wearable device according to claim 2, wherein the upper electrode and the circuit board are electrically connected through an elastic sheet, and both ends of the elastic sheet each has a protrusion, and the protrusions are in contact with the upper electrode and the circuit board, respectively.

12. The wearable device according to claim 3, wherein the upper electrode and the circuit board are electrically connected through an elastic sheet, and both ends of the elastic sheet each has a protrusion, and the protrusions are in contact with the upper electrode and the circuit board, respectively.

13. The wearable device according to claim 4, wherein the upper electrode and the circuit board are electrically connected through an elastic sheet, and both ends of the elastic sheet each has a protrusion, and the protrusions are in contact with the upper electrode and the circuit board, respectively.

14. The wearable device according to claim 5, wherein the upper electrode and the circuit board are electrically connected through an elastic sheet, and both ends of the elastic sheet each has a protrusion, and the protrusions are in contact with the upper electrode and the circuit board, respectively.

15. The wearable device according to claim 6, wherein the upper electrode and the circuit board are electrically connected through an elastic sheet, and both ends of the elastic sheet each has a protrusion, and the protrusions are in contact with the upper electrode and the circuit board, respectively.

16. The wearable device according to claim 7, wherein the upper electrode and the circuit board are electrically connected through an elastic sheet, and both ends of the elastic sheet each has a protrusion, and the protrusions are in contact with the upper electrode and the circuit board, respectively.
